(19) United States
(12) Patent Application Publication
(10) Pub. No.: US 2004/0000214 A1
(43) Pub. Date: Jan. 1, 2004

(54) Method for attaching balance weights to a shaft

(76) Inventor: Mark Williams, Erie, CO (US)

Correspondence Address: The Law Offices of Timothy J. Klima, Suite 330, One Massachusetts Avenue NW, Washington, DC, 20001, US

(21) Appl. No.: 10/180,039

(22) Filed: Jun. 27, 2002

(51) Int. Cl. F16F 15/22

(52) U.S. Cl. 74/573 R

(57) ABSTRACT

A method for attaching a balance weight to a shaft and the resulting shaft is disclosed. The balance weight is attached to the shaft in a desired position with an adhesive. A band of shrinkable material is placed over the positioned balance weight and shaft and the band of shrinkable material is shrunk to clamp the balance weight between the band of shrinkable material and the shaft. In one embodiment, the shaft is then rotated to determine a dynamic balance of the shaft after the band of shrinkable material has been shrunk but before the adhesive has cured.

### FIELD OF THE INVENTION

The present invention relates to a method for attaching balance weights to a shaft that will be rotated, as well as a shaft manufactured according to the method.

### BACKGROUND OF THE INVENTION

It is desirable to balance shafts that are to be rotated at relatively high speeds to prevent vibration resulting when an out-of-balance shaft is rotated. Such vibration can be destructive to the shaft and other components, increases noise levels resulting from operation of the shaft, reduces comfort levels of operators near the shaft and can reduce power transmission through the shaft. Such balancing is particularly desirable with respect to automotive drive shafts formed from hollow tubing. Since the drive shaft is hollow, correspondingly lighter and heavier areas of the shaft are farther from an axis of the shaft and have a greater moment effect on the balance of the shaft, as compared to a solid shaft of similar weight.

It is known to balance such shafts, either through static or dynamic balancing methods, by attaching one or more weights to comparatively light portions of the shaft. Such balance weights are known to be attached to shafts with rivets, adhesive and welding. When a balance weight is welded to the shaft, the weight is usually placed near the weld between the shaft tube and the yoke to minimize the distortion effect on the driveshaft from the welding. However, it has been found to be preferable to position the balance weight at approximately ⅓of the distance of the shaft tube length to better place the balance weight near the actual shaft unbalance. Welding the balance weight to the shaft tube in this position can result in undesirable distortion from the welding process. The welding can also negatively affect the metallurgical composition of the shaft tube, decreasing the strength of the shaft tube.

The balance weights can also be attached to the shaft with adhesive, avoiding distortion from welding, but the shaft cannot then be tested for dynamic balance until the adhesive has cured to prevent the balance weight from separating from the shaft when the shaft is rotated during the balancing process. Such time delays increase the amount of time to complete a shaft and increase the cost of the balancing process. There is also a danger that the balance weight can be unintentionally repositioned or knocked off of the shaft due to mishandling of the shaft prior to curing of the adhesive.

Rivets or screws can also be used to attach the balance weight to the shaft, but such methods are time-consuming, require additional machining or metal working, can be difficult to control with respect to accurate positioning of the balance weight and can potentially affect the integrity of the shaft.

A method of attaching a balance weight to a shaft to overcome the deficiencies of the known methods above is therefore desired.

### BRIEF SUMMARY OF THE PRESENT INVENTION

The present invention is a method for attaching a balance weight to a shaft and the resulting shaft. The balance weight is attached to the shaft in a desired position with an adhesive. A band of shrinkable material is placed over the positioned balance weight and shaft and the band of shrinkable material is shrunk to clamp the balance weight between the band of shrinkable material and the shaft. In one embodiment, the shaft is then rotated to determine a dynamic balance of the shaft after the band of shrinkable material has been shrunk but before the adhesive has cured.

It is an object of the present invention to provide a mechanism for attaching a balance weight to a shaft without welding the balance weight to the shaft.

It is a further object of the present invention to provide a mechanism for attaching a balance weight to a shaft without machining or metal working the shaft.

It is a further object of the present invention to provide an auxiliary mechanism for securing the position of a balance weight attached to a shaft with an adhesive.

It is further object of the present invention to provide an auxiliary mechanism for securing the position of a balance weight with respect to a shaft prior to curing of an adhesive positioned between the balance weight and the shaft.

With the foregoing in mind, other objects, features and advantages of the present invention will become more apparent upon consideration of the following description and the appended claims with reference to the accompanying drawings, all of which form part of this specification, wherein like reference numerals designate corresponding parts in various figures.

### BRIEF DESCRIPTION OF THE DRAWINGS

FIG. 1 is a partial perspective view of a shaft of the present invention; and

FIG. 2 is a sectional view of the shaft of the present invention taken along section line 2-2 of FIG. 1.

### DETAILED DESCRIPTION OF THE INVENTION

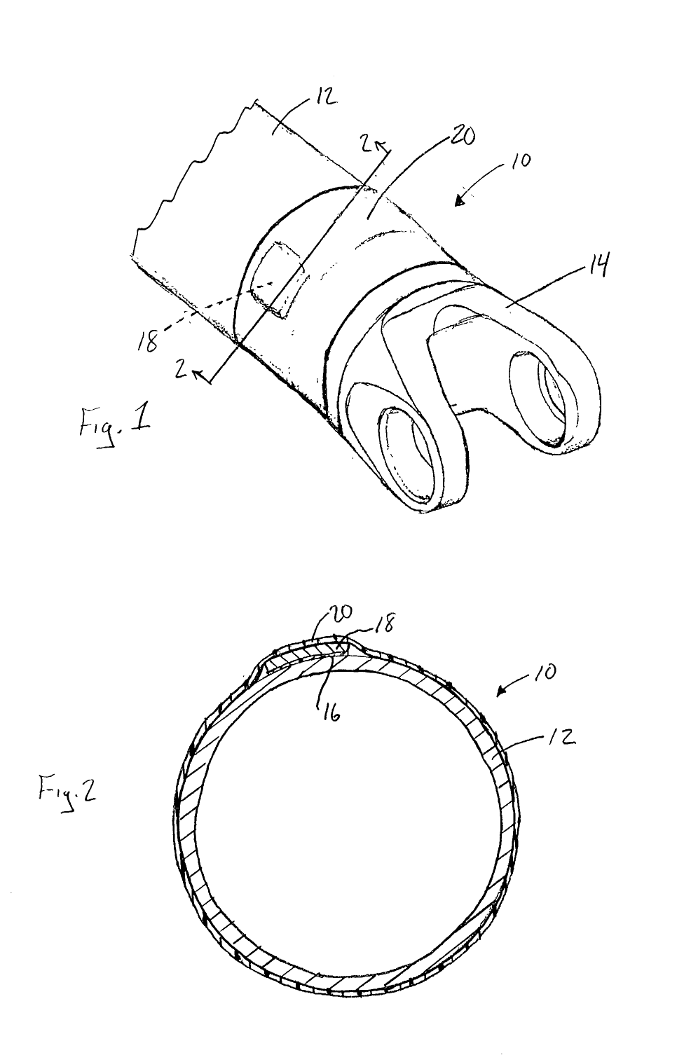

As shown in FIG. 1, the shaft 10 of the present invention includes an elongated tube portion 12. A yoke 14 is attached to each end in a known manner (with only one being shown) for attachment between driving and driven mechanisms. The tube portion 12 is shown as being hollow (see FIG. 2) but can also be solid or include internal structure. The tube 12 is shown as being constructed of metal, such as steel, aluminum or other metal alloy, but the tube 12 can also be constructed of other materials, such as plastic, carbon fiber or other composites.

To balance the shaft 10, the shaft 10 is spun in a balancing machine to determine where the shaft is out of balance. Once this has been done, it can be determined where and how much weight must be added to the shaft (and/or weight removed from the shaft). Adhesive 16 can then be applied to the tube 12 and/or one or more balance weights 18 and the balance weights positioned on an exterior surface of the tube 10 in locations that will place the shaft in balance. See FIG. 2. The adhesive 16 can be in a fluid form, can be in the form of double-sided adhesive tape, or can be in another form.

A band of shrinkable material 20 is then placed over the tube 12 and the positioned balance weight 18. The band of shrinkable material 20 is then shrunk in the necessary manner to clamp the balance weight 18 between the band 20 and the tube 12. In the preferred embodiment, the band 20 is constructed of heat-shrinkable tubing and is shrunk by applying heat from, for example, a hot air blower. The heat necessary to shrink the band 20 is generally of a much lower magnitude than the heat generated by welding. It is also contemplated that the band 20 can be constructed of other materials and shrunk in other manners.

The shrunken band 20 provides additional mechanical strength to the bond holding the balance weight 18 to the tube 12. The shrunken band 20 will thus maintain the balance weight 18 in the desired position, even though the adhesive has not yet cured. In this manner, the shaft 10 can be rechecked for the accuracy of the balancing operation immediately after shrinking of the band 20. It is not necessary to wait for the adhesive 16 to cure. This method can also be used to add to the strength of the bond with adhesives that do not require curing time or with weaker adhesives that are only used to initially position the balance weight 18. The specific material and thickness of the band 20 can be selected to provide the strength necessary to maintain the position of the balance weight 18 when the shaft 10 is rotated. For additional strength, one or more additional bands 20 can be applied over the shrunken first band 20 and shrunk into position.

An axial length of the band 20 can be altered as required to cover a desired portion of the balance weight 18. In a preferred embodiment, the band 20 will completely cover the balance weight 18 and seal it from the atmosphere in the shrunken state to prevent dirt, moisture and abrasion from compromising the adhesive bond between the balance weight 18 and the tube 12. The axial length of the band 20 can also be altered to vary the effect of the shrunken band on the natural harmonics of the tube 12.

Since the band 20 in the shrunken state generally uniformly encompasses a perimeter of the tube 12, and since the band 20 is constructed of a generally light weight material, application of the band 20 to the tube 12 will not itself significantly affect the balance of the shaft 10. In a preferred embodiment, exposed edges of the balance weight 18 can be chamfered so as not to cut or damage the band 20 during or after installation of the band 20 on the tube 12.

The various features described above can be used in any desired combination with one another.

What is claimed is:

1. A method for attaching a balance weight to a shaft, comprising:
attaching the balance weight to the shaft in a desired position with an adhesive;
placing a band of shrinkable material over the positioned balance weight and shaft;
shrinking the band of shrinkable material to clamp the balance weight between the band of shrinkable material and the shaft.

2. The method of claim 1, wherein the adhesive is placed on the shaft in a fluid form.

3. The method of claim 2, wherein the band of shrinkable material is shrunk by applying heat to the shrinkable material.

4. The method of claim 3, and further comprising:
rotating the shaft to determine a dynamic balance of the shaft after the band of shrinkable material has been shrunk but before the adhesive has cured.

5. The method of claim 1, wherein the adhesive is placed on the shaft as a double-sided adhesive tape.

6. The method of claim 5, wherein the band of shrinkable material is shrunk by applying heat to the shrinkable material.

7. The method of claim 5, and further comprising:
rotating the shaft to determine a dynamic balance of the shaft after the band of shrinkable material has been shrunk but before the adhesive has cured.

8. The method of claim 1, wherein the band of shrinkable material is shrunk by applying heat to the shrinkable material.

9. The method of claim 8, and further comprising:
rotating the shaft to determine a dynamic balance of the shaft after the band of shrinkable material has been shrunk but before the adhesive has cured.

10. The method of claim 1, and further comprising:
rotating the shaft to determine a dynamic balance of the shaft after the band of shrinkable material has been shrunk but before the adhesive has cured.

11. The method of claim 1, and further comprising:
completely covering the balance weight with the band of shrinkable material and shrinking the band to seal the balance weight from the atmosphere.

12. The method of claim 1, and further comprising:
altering an axial length of the band of shrinkable material to vary an effect of the band on natural harmonics of the shaft.

13. A shaft, comprising:
an elongated tube portion;
a balance weight positioned on an exterior surface of the tube portion in a desired position;
an adhesive material positioned between the balance weight and the tube portion for affixing the balance weight to the tube portion;
a band of shrinkable material positioned in a shrunken state over the balance weight and tube portion to clamp the balance weight to the tube portion.

14. A shaft as in claim 13, wherein the band of shrinkable material is constructed of a heat shrinkable material.

15. A shaft as in claim 14, wherein the band of shrinkable material completely covers the balance weight to seal the balance weight from the atmosphere.

16. A shaft as in claim 15, wherein the band of shrinkable material completely covers the balance weight to seal the balance weight from the atmosphere.

17. A shaft as in claim 16, wherein the band of shrinkable material completely covers the balance weight to seal the balance weight from the atmosphere.

18. A shaft as in claim 17, wherein exposed edges of the balance weight are chamfered.

19. A shaft as in claim 13, wherein the band of shrinkable material completely covers the balance weight to seal the balance weight from the atmosphere.

20. A shaft as in claim 13, wherein exposed edges of the balance weight are chamfered.
